(19) United States
(12) Patent Application Publication
(10) Pub. No.: US 2004/0109503 A1
(43) Pub. Date: Jun. 10, 2004

(54) High speed motion vector estimation apparatus and method

(75) Inventor: Young-Ho Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/726,521

(22) Filed: Dec. 4, 2003

(30) Foreign Application Priority Data
Dec. 5, 2002 (KR) 2002-77078

(51) Int. Cl. H04N 7/12

(52) U.S. Cl. 375/240.16

(57) ABSTRACT

An apparatus for and a method of motion vector estimation which shortens a time of motion vector estimation. Vertical motion vectors of a second frame are calculated with reference to a first frame. Vertical reference positions are decided when calculating horizontal motion vectors of the second frame according to the vertical motion vectors. Horizontal motion vectors of the second frame are calculated in lines according to the decided vertical reference positions. When calculating motion vectors from the first frame and the subsequent second frame, calculation speed is increased by calculating vertical motion vectors first and reducing calculation amounts of horizontal motion vectors based on the vertical motion vector calculations.

### CROSS-REFERENCE TO RELATED APPLICATIONS

This application claims the benefit of Korean Patent Application No. 2002-77078, filed Dec. 5, 2002, in the Korean Intellectual Property Office, the disclosure of which is incorporated herein by reference.

### BACKGROUND OF THE INVENTION

1. Field of the Invention

The present invention relates to a motion vector estimation apparatus and a method of estimating motion vectors, and more particularly to a motion vector estimation apparatus for shortening a time to search for motion vectors and a method thereof.

2. Description of the Related Art

As an analog image signal is converted into, transmitted, and received as a digital signal, many apparatuses and methods for compressing the digital signal have been disclosed. The compression of an image signal is implemented by reconstructing an intermediate-stage image with reference to a previous image and a next image in a time domain. The reconstructed intermediate-stage image is expressed as a quantity of motion changes from the previous image, that is, through motion vectors.

FIG. 1 is a view for explaining a concept of motion prediction.

FIG. 1 illustrates a sequence of images displayed on the screen of an image display device such as television set, wherein a previous image A1, a next image A2, and a reconstructed image A3 are shown. Under an assumption that a ball A moves in an arrow direction as shown in image A1, a next image will appear as shown in image A2. Based on images A1 and A2, a position of the ball A between images A1 and A2 is predictable as shown in image A3. The direction shown in image A3 in which the ball A is moving is referred to as a motion vector, and a digital image signal can be transmitted or received with only motion vectors representing estimated intermediate images in the manner shown in image A3 instead of transmission and reception of a complete digital image signal.

FIG. 2A through FIG. 2D are views for conceptually explaining a method of obtaining motion vectors of images to be displayed on a television screen.

FIG. 2A shows a first frame image in an upper left portion of which a vertical region 1 and a horizontal region 2 that a displayed letter “A” occupies are shown.

FIG. 2B shows a second frame image displayed on the screen after a certain time lapses from the display of the first frame image on the screen. The letter “A” shown in FIG. 2B has moved down and right from the letter “A” shown in FIG. 2A and FIG. 2B shows a vertical region 3 and a horizontal region 4 that the letter “A” occupies on the screen. FIG. 2C shows vertical regions 1 and 3 shown in FIG. 2A and FIG. 2B. A vertical motion difference 5 between vertical regions shown becomes a vertical motion vector. FIG. 2D shows horizontal regions 2 and 4 shown in FIG. 2A and FIG. 2B. A difference 6 between horizontal regions shown becomes a horizontal motion vector. Search ranges where initial searches begin when searching for the vertical region difference and the horizontal region difference, respectively, shown in FIG. 2C and FIG. 2D, are indicated by −sr and +sr. After a search begins, if the same pattern is not searched for, the same pattern is continuously searched for with forming a new search range by moving pixel by pixel from the search ranges. As described above, if horizontal and vertical vectors are calculated from the first and second frames sequentially applied with time, the second frame can be presented with the motion vectors of the displayed first frame after the first frame is displayed on the screen.

FIG. 3 is a block diagram for showing a conventional motion vector estimation apparatus.

The motion vector estimation apparatus shown in FIG. 3 has a vertical pixel value calculation unit 30, a vertical motion vector selection unit 31, a horizontal pixel value calculation unit 40, and a horizontal motion vector selection unit 41.

The vertical pixel value calculation unit 30 adds and stores values of all pixels forming a first frame 10 and a second frame 20 by horizontal line (width direction). For example, when the first and second frames 10 and 20 have a resolution of 852×480 in the width (N as shown in FIG. 2B) and height (M as shown in FIG. 2A) directions respectively, an addition of the values, for example, luminance values, of pixels provided in respective lines is calculated by line, and each line corresponds to one addition value. Accordingly, the number of addition values calculated by line becomes 960 all together, that is, 480 values from the first frame and 480 values from the second frame. The vertical pixel value calculation unit 30 calculates differences between the stored 960 addition values and the addition values of the first and second frames 10 and 20 based on expression 1 as shown below, processes the differences into absolute values, and calculates line differences, that is, differences in the vertical direction, between the first and second frames 10 and 20.

$$V ( u ) = {\sum }_{i = sr}^{M - sr} \vert ( Vp ( i + u ) - Vn ( i ) ) \vert , \qquad ( 1 )$$

where V(u) denotes is a sum of absolute difference (SAD), sr denotes a search range, Vp denotes a function for calculating pixel values in horizontal lines of the first frame, Vn denotes a function for calculating pixel values in horizontal lines of the second frame, and u denotes a horizontal motion vector within a search range (−sr˜+sr).

The vertical motion vector selection unit 31 selects as a vertical motion vector the least absolute value in magnitude out of SAD values calculated, based on expression 1, by the vertical pixel value calculation unit 30. The vertical motion vector selection unit 31 selects as a vertical motion vector the least absolute value in magnitude out of motion vector values based on a theory that the same frame is likely to be searched when a difference among addition values obtained by adding in the vertical direction values of the pixels forming the first and second frames 10 and 20 is the least.

The horizontal pixel value calculation unit 40 adds and stores values of pixels provided in the first frame 10 and the second frame 20 by vertical line (height direction). For example, when the first frame 10 and the second frame 20 have a resolution of 852×480 in the width direction (N) and the height direction (M), respectively, the horizontal pixel value calculation unit 40 adds and stores the individual pixel values by vertical line formed in the vertical direction of each of 852 pixels. With the addition values stored in the horizontal pixel value calculation unit 40, differences among the addition values of the first frame 10 and the second frame 20 are calculated based on expression 2 as shown below, the differences are processed into absolute values, and change amounts in the horizontal direction, that is, horizontal motion vectors, that the first frame 10 and the second frame 20 have are calculated.

$$H ( j ) = {\sum }_{j = sr}^{N - sr} \vert ( Hp ( j + v ) - Hn ( j ) ) \vert , \qquad ( 2 )$$

where H(j) denotes SAD values, sr denotes a search range, Hp denotes a function for calculating vertical line pixel values of the first frame, Hn denotes a function for calculating vertical line pixel values of the second frame, and v denotes a vertical motion vector within a search range (−sr, sr).

The horizontal motion vector selection unit 41 selects as a horizontal motion vector the least absolute value in magnitude out of the SAD values calculated, based on expression 2, by the horizontal pixel value calculation unit 40. As stated above, the conventional method divides the first frame 10 and the second frame 20 in horizontal and vertical directions, and adds pixel values forming the first frame 10 and the second frame 20 in the respective directions to obtain motion vectors. That is, motion vectors can be calculated after all the pixel values of the first frame 10 and the second frame 20 have been obtained in the horizontal direction and the vertical direction. Accordingly, the motion vector calculations may be delayed when a broadcasting station transmits a compressed digital image signal to an image display device such as television set or where the image display device converts an input digital image signal from an interlace format into a progressive format. The delay in motion vector calculations causes difficulties in real-time responses upon the transmission and reception of the digital image signal and the conversion of the digital image signal into the progressive format.

### SUMMARY OF THE INVENTION

The present invention has been devised to solve the above and/or the problems. The present invention provides an apparatus for and a method of calculating motion vectors from an image signal at a high speed.

In an aspect of the present invention, a motion vector estimation apparatus for obtaining motion vectors of a second frame with reference to a first frame according to an embodiment of the present invention comprises a vertical motion vector calculation part which calculates vertical motion vectors of the second frame with reference to the first frame; an offset control part which decides vertical reference positions when calculating horizontal motion vectors of the second frame according to the vertical motion vectors; and a horizontal motion vector calculation part which calculates the horizontal motion vectors of the second frame in lines according to the vertical reference positions.

The vertical motion vector calculation part may comprise a vertical pixel value storage which adds values of pixels of each of horizontal lines forming the first frame to calculate vertical sums, and stores the vertical sums by horizontal line; and a first SAD value calculator which calculates differences between the vertical sums of the first frame and vertical sums of the second frame calculated by adding values of pixels of each of horizontal lines forming the second frame, and processes the differences into absolute values to calculate sums of absolute difference (SAD) values.

The first SAD value calculator may further comprise an adder which adds the differences between the vertical sums of the first frame and the vertical sums of the second frame; and a vertical motion vector selection unit which obtains absolute values for values added in the adder, and selects the least absolute value of the absolute values as a vertical motion vector.

The first SAD value calculator may calculate SAD values based on an expression:

$$V ( u ) = {\sum }_{i = sr}^{M - sr} \vert {\sum }_{j = 0}^{N - 1} Vp ( i + u , j ) - Vn ( i , j ) \vert ,$$

where M and N denote a width region and a height region of the first frame or the second frame, respectively, sr denotes a search range, i and j denote a pixel position in the width region and the height region, respectively, V(u) denotes an SAD value, Vp denotes a function for calculating a horizontal line pixel value of the first frame, Vn denotes a function for calculating a horizontal line pixel value of the second frame, and u denotes an amount of horizontal motion within a search range (−sr, sr).

The horizontal motion vector calculation part may further comprise a horizontal pixel value storage which adds values of pixels of each of vertical lines of the first frame to calculate horizontal sums, and stores the horizontal sums by vertical line; and a second SAD value calculator which calculates SAD values from differences between the horizontal sums of the first frame and the horizontal sums of the second frame, the SAD value calculation being carried out for horizontal lines decided according to the vertical reference positions.

The second SAD value calculator may further comprise a second adder which adds the differences between the horizontal sums of the first frame and the horizontal sums of the second frame; and a horizontal motion vector selection unit for obtaining absolute values for values added in the second adder, and selecting the least absolute value of the absolute values as a horizontal motion vector.

The second SAD value calculator may calculate SAD values based on an expression:

$$H ( v ) = {\sum }_{j = sr}^{N - sr} \vert {\sum }_{i = 0}^{M - 1} ( Vp ( i + mv , j + v ) - Vn ( i + mv , j ) ) \vert ,$$

where M and N denote a width region and a height region, respectively of the first frame or the second frame, sr denotes a search range, i and j denote a pixel position in the width region and the height region, respectively, mv denotes a vertical motion vector, H(v) denotes an SAD value, Vp denotes a function for calculating a horizontal line pixel value of the first frame, Vn denotes a function for calculating a vertical line pixel value of the second frame, and v denotes the position of a pixel that is changed in consideration of a vertical reference position obtained by the calculated vertical motion vector.

In an aspect of the invention, a method of estimating motion vector comprises calculating vertical motion vectors of the second frame with reference to the first frame; deciding vertical reference positions when calculating horizontal motion vectors of the second frame according to the vertical motion vectors; and calculating the horizontal motion vectors of the second frame in lines according to the vertical reference positions.

The calculating of the vertical motion vector includes adding values of pixels of each of horizontal lines forming the first frame to calculate vertical sums, and storing the vertical sums by horizontal line; and calculating differences between the vertical sums of the first frame and vertical sums of the second frame calculated by adding values of pixels of each of horizontal lines forming the second frame, and processing the differences into absolute values to calculate sums of absolute difference (SAD values).

The calculating of the horizontal motion vector may further comprise sequentially storing the horizontal sums of the first frame provided for lines of the first frame; and calculating SAD values from differences between the horizontal sums of the first frame and the horizontal sums of the second frame for horizontal lines decided according to the vertical reference positions.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of the preferred embodiments, taken in conjunction with the accompanying drawings of which:

FIG. 1 is a view for explaining a concept of motion prediction;

FIGS. 2A-2D are views for conceptually explaining a method of conventionally obtaining motion vectors of images to be displayed on a television screen;

FIG. 3 is a block diagram for showing a conventional motion vector estimation apparatus;

FIGS. 4A and 4B are views for conceptually explaining motion vector estimation according to the present invention;

FIG. 5 is a block diagram for showing a motion vector estimation apparatus according to an embodiment of the present invention;

FIG. 6 is a view for explaining detail operations of the vertical motion vector calculation unit of FIG. 5;

FIG. 7 is a view for explaining detail operations of the horizontal motion vector calculation unit of FIG. 5; and

FIG. 8 is a flow chart for explaining a method of motion vector estimation according to an embodiment of the present invention.

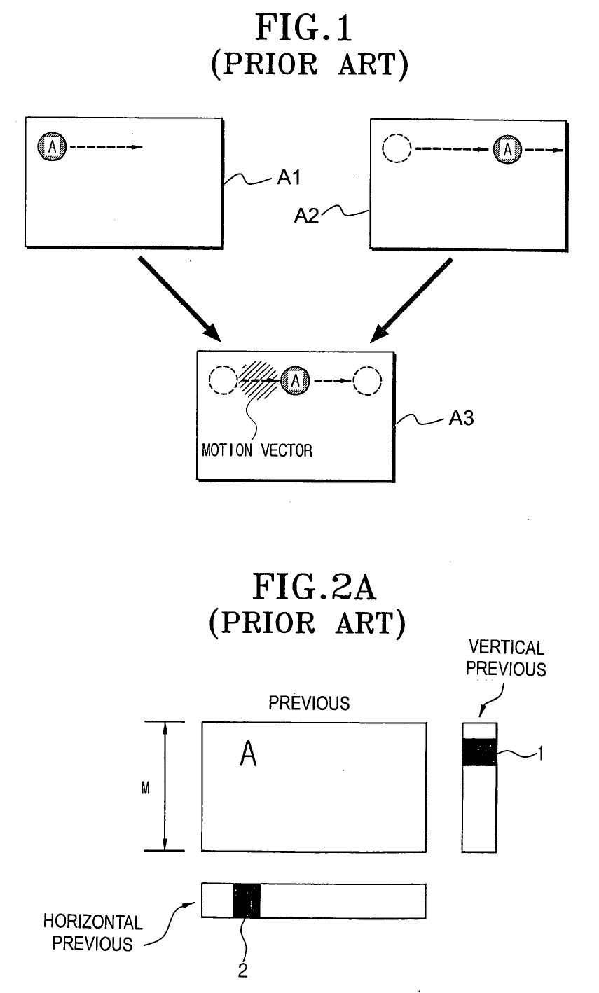

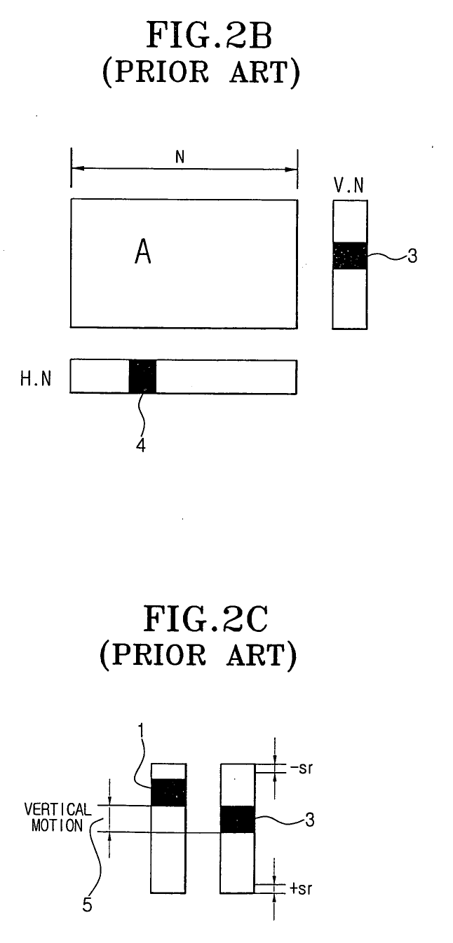

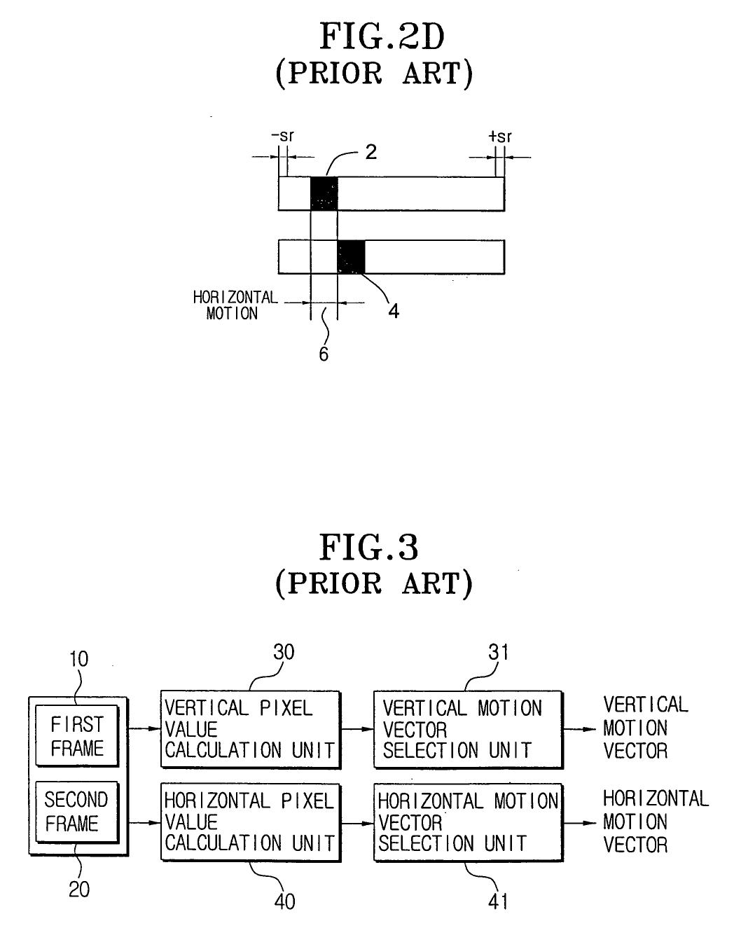

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

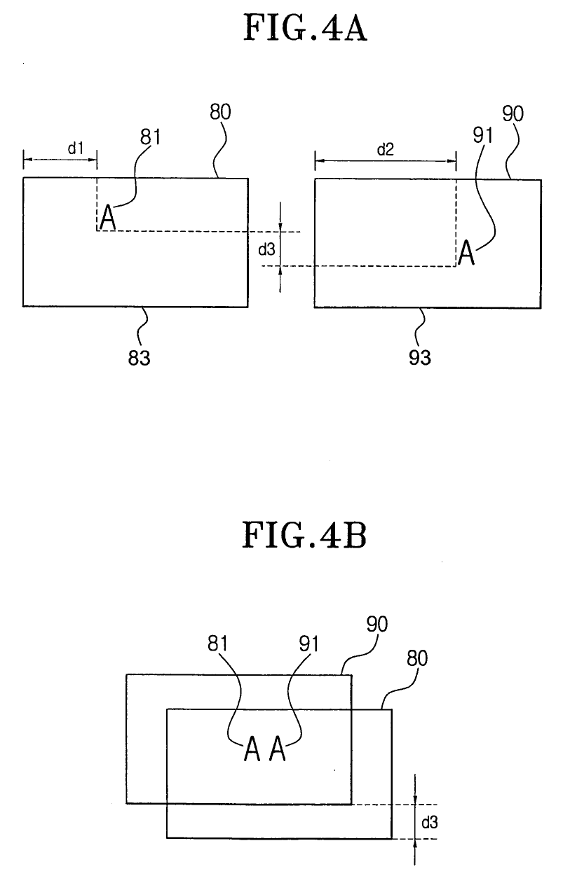

FIG. 4A and FIG. 4B are views for conceptually explaining the present invention.

FIG. 4A shows a letter “A” (81) in a first frame 80 spaced at a horizontal distance d1 from a left edge 83 of the first frame 80 and the letter “A” (91) of a second frame 90 spaced at a horizontal distance d2 from a left edge 93 of the second frame 90. The first frame 80 shown in FIG. 4A is displayed before the second frame 90; the first frame 80 and the second frame 90 have the same image data; and the second frame 90 displays image data moved as much as a certain distance, for example, a distance (d2−d1) in the horizontal direction and a distance d3 in the vertical direction.

FIG. 4B shows a method of estimating motion vectors for the letter “A” (81) of the first frame and the letter “A” (91) of the second frame shown in FIG. 4A. As shown in FIG. 4B, the letter “A” (81) of the first frame 80 and the letter “A” (91) of the second frame 90 are spaced as much as a distance d3, and, if the second frame 90 is positioned over the first frame 80 with the second frame 90 spaced at the distance d3 as shown in FIG. 4B, the letter “A” (81) of the first frame 80 and the letter “A” (91) of the second frame 90 are positioned in a horizontal line. In this state, motion vectors for the second frame 90 are obtainable with only the horizontal positions estimated from the letter “A” (81) of the first frame 80. That is, the present invention calculates a vertical motion vector, moves a comparison object, for example the letter “A” (91), of the second frame 90 by a vertical motion vector value, and obtains a horizontal motion vector at the moved position, to thereby reduce calculation amounts for the horizontal motion vectors, resulting in motion vector estimations at a high speed.

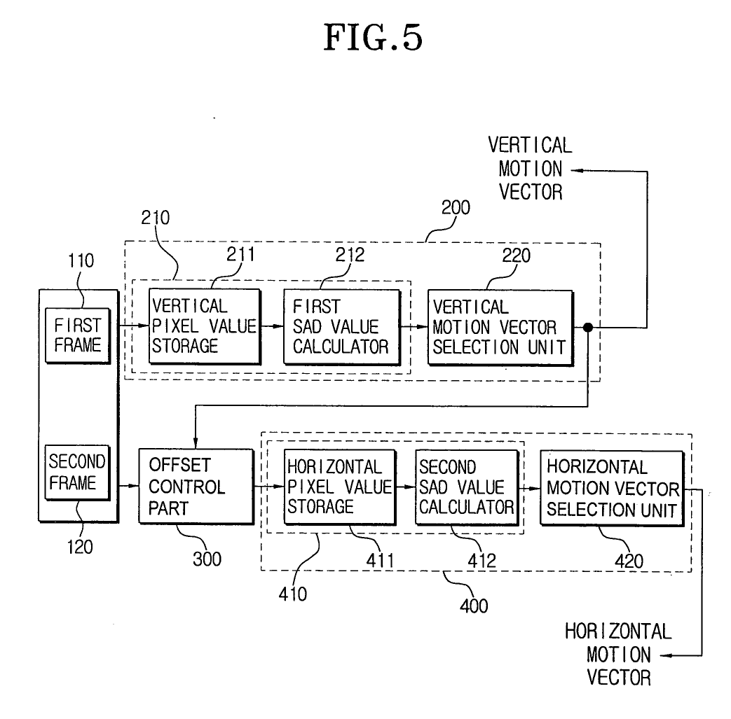

FIG. 5 is a block diagram for showing a motion vector estimation apparatus according to an embodiment of the present invention.

The motion vector estimation apparatus shown in FIG. 5 comprises a vertical motion vector calculation part 200, an offset control part 300, and a horizontal motion vector calculation part 400.

The vertical motion vector calculation part 200 calculates vertical motion vectors from a first frame 110 and a second frame 120.

The offset control part 300 sequentially provides the first frame 110 and the second frame 120 to the horizontal motion vector calculation part 400, and the second frame 120 is shifted by a predetermined amount in the vertical direction based on a vertical motion vector value applied from the vertical motion vector calculation part 200 and then applied to the horizontal motion vector calculation part 400.

The horizontal motion vector calculation part 400 inputs the first frame 110 applied from the offset control part 300 and the second frame 120 shifted by a predetermined amount by the offset control part 300, and calculates a horizontal motion vector. Accordingly, the horizontal motion vector calculation part 400 does not compare all the pixels forming the first frame 110 and the second frame 120, but compares specified horizontal lines only with reference to a vertical motion vector obtained in advance, when calculating the horizontal motion vector.

The vertical motion vector calculation part 200 may further comprise a vertical pixel value calculation unit 210 and a vertical motion vector selection unit 220, and the vertical pixel value calculation unit 210 may further comprise a vertical pixel value storage 211 and a first SAD value calculator 212.

The vertical pixel value storage 211, line by line, calculates and stores sums of values, for example, luminance values, of the pixels provided in all the lines forming the first frame 110 and the second frame 120. That is, a sum of pixel values is calculated for each of the lines forming the first frame 110 and the second frame 120. Next, the first SAD value calculator 212 inputs the sums from the vertical pixel value storage 211, and generates sums of absolute difference (SADs) through calculations based on expression 3 as shown below. The least SAD value of the calculated SAD values is selected as a vertical motion vector by the vertical motion vector selection unit 220.

$$V ( u ) = {\sum }_{i = sr}^{M - sr} \vert {\sum }_{j = 0}^{N - 1} Vp ( i + u , j ) - Vn ( i , j ) \vert , \qquad ( 3 )$$

where M and N denote a width region and a height region of the first frame 110 or the second frame 120, respectively, sr denotes a search range, i and j denote a pixel position in the width region and the height region, respectively, V(u) denotes an SAD value, Vp dentoes a function for calculating a horizontal line pixel value of the first frame 110, Vn denotes a function for calculating a horizontal line pixel value of the second frame 120, and u denotes denotes an amount of horizontal motion within a search range (−sr, sr).

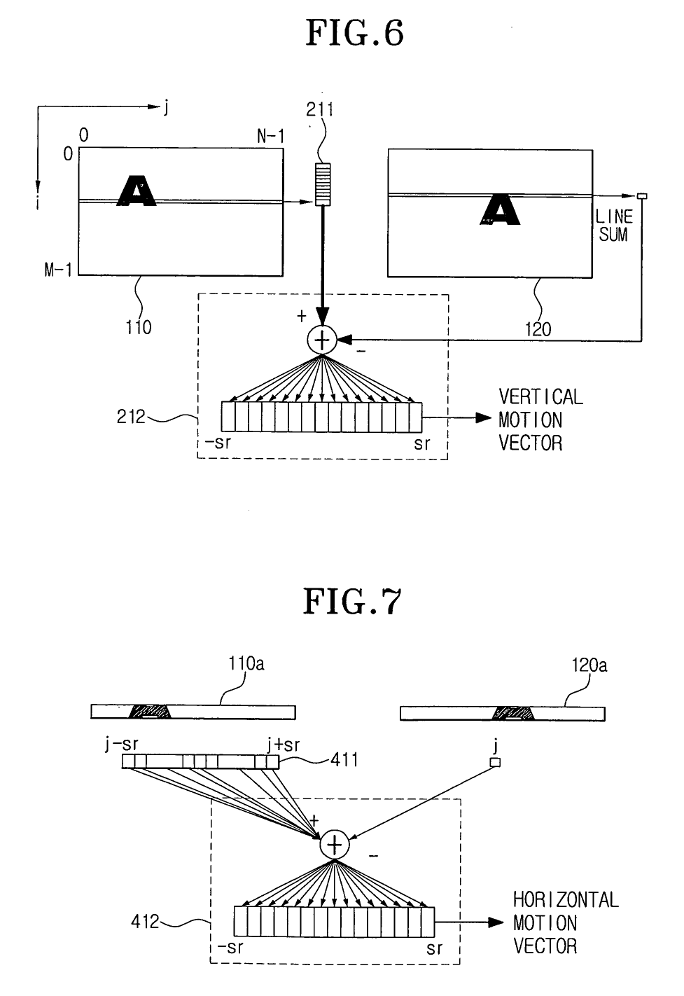

Hereinafter, operations of the vertical motion vector calculation part 200 shown in FIG. 5 will be described in more detail with reference to FIG. 6. Each of the first frame 110 and the second frame 120 shown in FIG. 6 is formed with M lines with N pixels in a line.

As described above, the vertical motion vector calculation part 200 may further comprise the vertical pixel value storage 211 and the first SAD value calculator 212. The vertical pixel value storage 211 adds and stores pixel values forming lines by line. The vertical pixel value storage 211 may be constructed with shift registers, and sequentially stores sums added by horizontal line.

Next, the first SAD value calculator 212 adds, one by one, the sums of the first frame 110 and the sums of respective lines of the second frame 120 which are stored in the vertical pixel value storage 211. The first SAD value calculator 212 inputs the sums of the first frame 110 from the vertical pixel value storage 211, and calculates SAD values every time when inputting the sums of the second frame 120 one by one.

The operations of the first SAD value calculator 212 are the same as shown in expression 3, and the calculated SAD values are applied to the vertical motion vector selection part 220. The first SAD value calculator 212 inputs the pixel values of the first frame 110 by line and the pixel values of the second frame 120 from the vertical pixel value storage 211 structured with shift registers and completes calculations at the instant when inputting all data of the first frame 110 and the second frame 120 occurs. Accordingly, the first SAD value calculator 212 finishes SAD value calculations before starting vertical motion vector calculations after inputting all pixel values from the first frame and the second frame.

The horizontal motion vector calculation part 400 may further comprise a horizontal pixel value calculation unit 410 and a horizontal motion vector selection unit 420, and the horizontal pixel value calculation unit 410 may further comprise a horizontal pixel value storage 411 and a second SAD value calculator 412. Hereinafter, the horizontal motion vector calculation part 400 will be described with reference to FIG. 7.

As shown in FIG. 7, the vertical region of the letter “A” of the first frame 110 and the second frame 120 to be stored in the horizontal pixel value storage 411 has the same vertical region by the offset control part 300. That is, the letter region 110a of the first frame 110 and the letter region 120a of the second frame 120 are different in the horizontal direction, but have the same motion vector in the vertical direction. Accordingly, the horizontal motion vector calculation part 400 does not need to compare all the vertical lines of the first frame 110 and the second frame 120. Therefore, the second SAD value calculator 412 calculates SAD values including vertical motion vectors, and the SAD value calculations are carried out based on expression 4 as follows:

$$H ( v ) = {\sum }_{j = sr}^{N - sr} \vert {\sum }_{i = 0}^{M - 1} ( Vp ( i + mv , j + v ) - Vn ( i + mv , j ) ) \vert , \qquad ( 4 )$$

where M and N denote a width region and a height region of the first frame 110 or the second frame 120, respectively, sr denotes a search range, i and j denote a pixel position in the width region and the height region, respectively, mv denotes a vertical motion vector, H(v) denotes an SAD value, Vp denotes a function for calculating a horizontal line pixel value of the first frame 110, Vn denotes a function for calculating a vertical line pixel value of the second frame 120, and v denotes the position of a pixel that is changed in consideration of a vertical reference position obtained by the calculated vertical motion vector.

As described above, the motion vector estimation apparatus of the present invention operates at a high speed when compressing a digital image signal or converting the interlace format into the progressive format by first calculating vertical motion vectors to reduce calculation amounts for the horizontal motion vectors based on the vertical motion vector calculations.

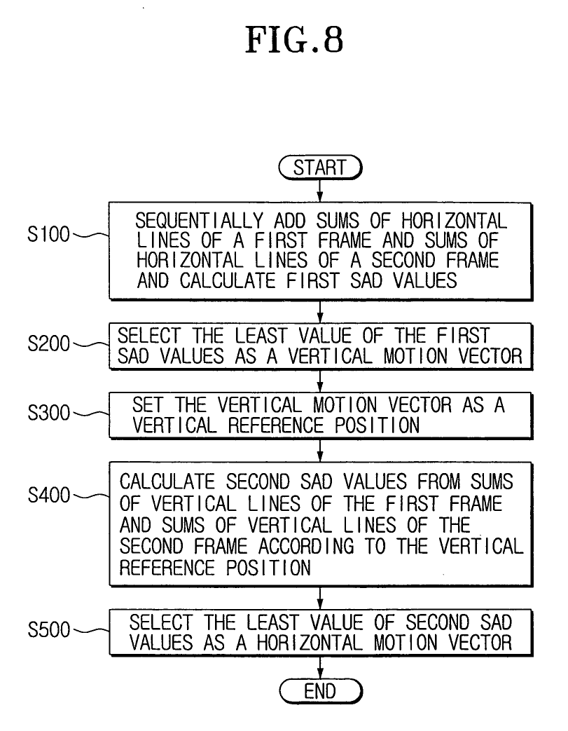

FIG. 8 is a flow chart for showing a method of motion vector estimation according to an embodiment of the present invention.

Vertical pixel values for example, luminance values, of the pixels provided in all the lines forming the first frame 110 and the second frame 120 are summed and stored line by line. That is, a sum of pixel values is provided for each of the lines forming the first frame 110 and the second frame 120. Next, the first SAD value calculator 212 of the vertical pixel value calculation unit 210 calculates the sums of the first frame 110 and the second frame 120 based on expression 3, and then generates sums of absolute differences (SADs) at operation S300.

The vertical motion vector selection unit 220 selects the least SAD value of the calculated SAD values in the first SAD value calculator 212 as a vertical motion vector at operation S200.

The offset control part 300 sequentially provides the first frame 110 and the second frame 120 to the horizontal motion vector calculation part 400, and the second frame 120 is shifted by a predetermined amount based on a the vertical motion vector value applied from the vertical motion vector calculation part 200. That is, the offset control unit 300 sets a vertical motion vector to a vertical reference position of the second frame 120 at operation S300.

The second SAD value calculator 412 adds sums of the first frame 110 and sums of the second frame 120 shifted in the vertical direction according to the vertical reference position set in the offset control part 300, and calculates absolute values, that is, SAD values. Accordingly, the second SAD value calculator 412 is not required to compare all the horizontal lines of the first frame 110 and the second frame 120, but calculates only a horizontal motion amount, that is, a horizontal motion vector with respect to a horizontal line selected by the vertical reference position provided in the offset control unit 300. By doing so, the horizontal motion vector calculation part 400 of the present invention reduces calculation amounts and calculation time compared to a conventional method of calculating a motion vector by comparing all the horizontal lines of the first frame 110 and the second frame 120.

Lastly, the horizontal motion vector selection unit 420 selects as a horizontal motion vector the least SAD value of the SAD values calculated in the second SAD value calculator 412.

As described above, the present invention, when calculating motion vectors from the first frame and the subsequent second frame, can calculate motion vectors at a high speed compared to the prior art by calculating vertical motion vectors first and reducing calculation amounts of horizontal motion vectors based on the vertical motion vector calculations. Such a motion vector calculation method can be applied to the hand-shivering correction or the like of digital cameras and camcorders upon conversions of a digital image signal from the interlace format into the progressive format.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A motion vector estimation apparatus for obtaining motion vectors of a second frame with reference to a first frame, comprising:
a vertical motion vector calculation part which calculates vertical motion vectors of the second frame with reference to the first frame;
an offset control part which decides vertical reference positions when calculating horizontal motion vectors of the second frame according to the vertical motion vectors; and
a horizontal motion vector calculation part which calculates the horizontal motion vectors of the second frame in lines according to the vertical reference positions.

2. The motion vector estimation apparatus as claimed in claim 1, wherein the vertical motion vector calculation part comprises:
a vertical pixel value storage which adds values of pixels of each of horizontal lines forming the first frame to calculate vertical sums, and stores the vertical sums by horizontal line; and
a first SAD value calculator which calculates differences between the vertical sums of the first frame and vertical sums of the second frame calculated by adding values of pixels of each of horizontal lines forming the second frame, and processes the differences into absolute values to calculate sums of absolute difference (SAD) values.

3. The motion vector estimation apparatus as claimed in claim 2, wherein the first SAD value calculator comprises:
an adder which adds the differences between the vertical sums of the first frame and the vertical sums of the second frame; and
a vertical motion vector selection unit which obtains absolute values for values added in the adder, and selects the least absolute value of the absolute values as a vertical motion vector.

4. The motion vector estimation apparatus as claimed in claim 3, wherein the first SAD value calculator calculates SAD values based on an expression:
$$V ( u ) = {\sum }_{i = sr}^{M - sr} \vert {\sum }_{j = 0}^{N - 1} Vp ( i + u , j ) - Vn ( i , j ) \vert ,$$
wherein M and N denote a width region and a height region, respectively, of the first frame or the second frame, sr denotes a search range, i and j denote a pixel position in the width region and the height region, respectively, V(u) denotes one of the SAD values, Vp denotes a function for calculating a horizontal line pixel value of the first frame, Vn denotes a function for calculating a horizontal line pixel value of the second frame and u denotes an amount of horizontal motion within a search range (−sr, sr).

5. The motion vector estimation apparatus as claimed in claim 2, wherein the horizontal motion vector calculation part comprises:
a horizontal pixel value storage which adds values of pixels of each of vertical lines of the first frame to calculate horizontal sums, and stores the horizontal sums by vertical line; and
a second SAD value calculator which calculates SAD values from differences between the horizontal sums of the first frame and the horizontal sums of the second frame, wherein the SAD values are calculated for horizontal lines decided according to the vertical reference positions.

6. The motion vector estimation apparatus as claimed in claim 5, wherein the second SAD value calculator comprises:
a second adder which adds the differences between the horizontal sums of the first frame and the horizontal sums of the second frame; and
a horizontal motion vector selection unit which obtains absolute values for values added in the second adder, and selects the least absolute value of the absolute values as a horizontal motion vector.

7. The motion vector estimation apparatus as claimed in claim 6, wherein the second SAD value calculator calculates the SAD values based on an expression:
$$H ( v ) = {\sum }_{j = sr}^{N - sr} \vert {\sum }_{i = 0}^{M - 1} ( Vp ( i + mv , j + v ) - Vn ( i + mv , j ) ) \vert ,$$
where M and N denote a width region and a height region, respectively, of the first frame or the second frame, sr denotes a search range, i and j denote a pixel position in the width region and the height region, respectively, mv denotes a vertical motion vector, H(v) denotes a SAD value, Vp denotes a function for calculating a horizontal line pixel value of the first frame, Vn denotes a function for calculating a vertical line pixel value of the second frame, and v denotes the position of a pixel that is changed in consideration of a vertical reference position obtained by the calculated vertical motion vector.

8. A method of estimating motion vectors to obtain motion vectors of a second frame with reference to a first frame, the method comprising:
calculating vertical motion vectors of the second frame with reference to the first frame;
deciding vertical reference positions when calculating horizontal motion vectors of the second frame according to the vertical motion vectors; and
calculating the horizontal motion vectors of the second frame in lines according to the vertical reference positions.

9. The method of estimating motion vectors as claimed in claim 8, wherein the calculating of the vertical motion vector comprises:
adding values of pixels of each of horizontal lines forming the first frame to calculate vertical sums, and storing the vertical sums by horizontal line; and
calculating differences between the vertical sums of the first frame and vertical sums of the second frame calculated by adding values of pixels of each of horizontal lines forming the second frame, and processing the differences into absolute values to calculate sums of absolute difference (SAD) values.

10. The motion vector estimation method as claimed in claim 8, wherein the calculating of the horizontal motion vector comprises:
sequentially storing horizontal sums for lines of the first frame; and
calculating SAD values from differences between the horizontal sums for the lines of the first frame and horizontal sums for lines of the second frame for horizontal lines decided according to the vertical reference positions.

11. A motion vector estimation apparatus for obtaining motion vectors of a second frame with reference to a first frame, comprising:
a vertical motion vector calculation part which calculates vertical motion vectors of the second frame with reference to the first frame; and
a horizontal motion vector calculation part which reduces calculation amounts of horizontal motion vectors of the second frame based upon the vertical motion vectors.
